(19) United States
(12) Patent Application Publication
(10) Pub. No.: US 2026/0093198 A1
(43) Pub. Date: Apr. 2, 2026

(54) IMAGE FORMING SYSTEM AND IMAGE READING APPARATUS

(71) Applicant: CANON KABUSHIKI KAISHA, Tokyo (JP)

(72) Inventor: YUDAI NEMOTO, Chiba (JP)

(21) Appl. No.: 19/338,402

(22) Filed: Sep. 24, 2025

(30) Foreign Application Priority Data
Sep. 30, 2024 (JP) 2024-170713

(51) Int. Cl. G03G 15/00; G03G 15/20; G03G 15/23; G06K 15/02; H04N 1/00

(52) U.S. Cl. CPC G03G 15/5062; G03G 15/2021; G03G 15/235; G03G 15/6567; G06K 15/027; H04N 1/00795; G03G 2215/00666; H04N 2201/0081

(57) ABSTRACT

An image forming system includes an image forming unit configured to form an image on a sheet, a reversing portion in which a front side and a back side of the sheet are to be reversed in order to form an image on a surface opposite to a surface of the sheet on which the image has been formed by the image forming unit, a duplex-printing conveying path for use in conveying the sheet having the front side and the back side reversed by the reversing portion to the image forming unit, a registration unit configured to correct a skew of the sheet conveyed to the duplex-printing conveying path, and an image reading sensor configured to read the image formed on the sheet having the skew corrected by the registration unit in the duplex-printing conveying path.

### BACKGROUND

### Field of the Technology

The present disclosure relates to an image reading apparatus for reading an image formed on a sheet and an image forming system including such an image reading apparatus.

### Description of the Related Art

An image forming apparatus has a configuration for performing image adjustment (for example, density adjustment and hue adjustment). Such an image forming apparatus includes, for example, a built-in image reading sensor (for example, a color sensor) as an image reading apparatus. The image forming apparatus reads, by the image reading sensor, an image for image adjustment (hereinafter referred to as “adjusting image”) formed on a sheet, and executes image adjustment based on a reading result of the adjusting image (United States Patent No. 9,031,468).

In Japanese Patent Application Laid-open No. 2024-3975, there is disclosed an image forming apparatus in which the image reading sensor is provided on a duplex-printing conveying portion. In this configuration, a skew of a sheet conveyed toward a transfer portion (secondary transfer portion) at which an image is transferred onto the sheet is corrected, and an image is transferred onto a predetermined position on the sheet. When the image adjustment is executed, the skew of the sheet before having the adjusting image transferred thereon is corrected so that the adjusting image passes through a reading position of the image reading sensor.

When the adjusting image printed on the sheet is to be read by the image reading sensor, it is required to accurately convey the adjusting image to the reading position of the image reading sensor. In Japanese Patent Application Laid-open No. 2024-3975, the adjusting image can be formed at a predetermined position of the sheet, but there is a possibility that the skew of the sheet changes while the sheet is conveyed from the transfer portion (secondary transfer portion) to the reading position of the image reading sensor. In this case, the adjusting image may not be accurately conveyed to the reading position of the image reading sensor, and hence the image reading sensor may not be able to read the adjusting image on the sheet. In particular, the skew of the sheet changes as a travel distance of the sheet is increased along with the conveyance of the sheet to the duplex-printing conveying portion. Accordingly, in the configuration as described in Japanese Patent Application Laid-open No. 2024-3975, the adjusting image may not be accurately conveyed to the reading position of the image reading sensor and thus the adjusting image cannot be read.

### SUMMARY

An image forming system according to one embodiment of the present disclosure includes an image forming unit configured to form an image on a sheet, a reversing portion in which a front side and a back side of the sheet are to be reversed in order to form an image on a surface opposite to a surface of the sheet on which the image has been formed by the image forming unit, a duplex-printing conveying path for use in conveying the sheet having the front side and the back side reversed by the reversing portion to the image forming unit, a registration unit configured to correct a skew of the sheet conveyed to the duplex-printing conveying path, and an image reading sensor configured to read the image formed on the sheet having the skew corrected by the registration unit in the duplex-printing conveying path.

An image reading apparatus, according to another embodiment, to be provided in an image forming system that is capable of forming images on both sides of a sheet, the image forming system includes an image forming unit configured to form an image on a sheet, a reversing portion in which a front side and a back side of the sheet are to be reversed in order to form an image on a surface opposite to a surface of the sheet on which the image has been formed by the image forming unit, a duplex-printing conveying path for use in conveying the sheet having the front side and the back side reversed by the reversing portion to the image forming unit, the image reading apparatus includes a registration unit configured to correct a skew of the sheet conveyed to the duplex-printing conveying path, and an image reading sensor configured to read the image formed on the sheet having the skew corrected by the registration unit in the duplex-printing conveying path.

Features of the present disclosure will become apparent from the following description of embodiments with reference to the attached drawings. The following description of embodiments is described by way of example.

### BRIEF DESCRIPTION OF THE DRAWINGS

FIG. 1 is a configuration view of an inkjet recording apparatus.

FIG. 2 is a configuration view of a fixing module and a drying module.

FIG. 3 is a configuration view of a second registration unit.

FIG. 4 is a cross-sectional view of a color measuring unit.

FIG. 5 is a view of the color measuring unit as viewed from a sponge roller side.

FIG. 6 is an explanatory view of a test chart.

FIG. 7 is an explanatory view of a posture of a sheet.

FIG. 8 is an explanatory view of a reading position.

FIG. 9 is an explanatory view of the reading position.

FIG. 10 is an explanatory view of the reading position.

FIG. 11 is a configuration view of an inkjet recording apparatus.

### DESCRIPTION OF THE EMBODIMENTS

Now, referring to the accompanying drawings, a description is given of at least one exemplary embodiment of the present disclosure.

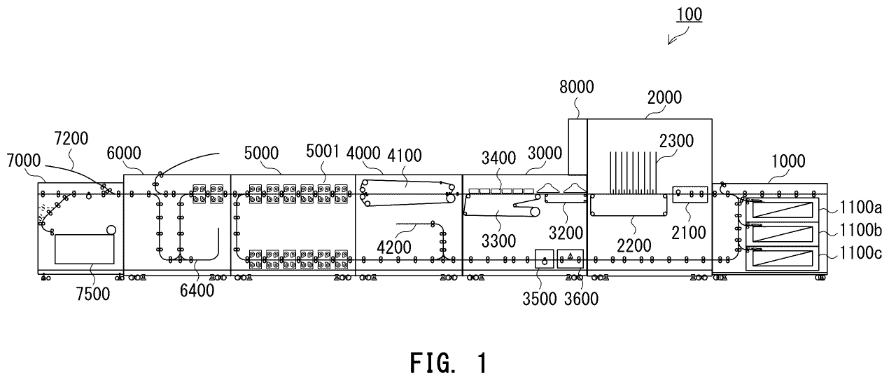

FIG. 1 is a configuration view of an inkjet recording apparatus serving as an image forming system of the at least one embodiment. An inkjet recording apparatus 100 in the at least one embodiment generates a printed product by forming an ink image on a sheet with use of two liquids which are a reaction liquid and ink. The inkjet recording apparatus 100 of the at least one embodiment includes a sheet feeding module 1000, a print module 2000, a drying module 3000, a fixing module 4000, a cooling module 5000, a reversing module 6000, a delivery stacking module 7000, a control device 8000, and the like. A sheet having a shape of cut paper on which an image is to be printed is fed from the sheet feeding module 1000, is conveyed along a conveying path, receives predetermined processing relating to image formation at each module, and is delivered from the delivery stacking module 7000.

The sheet feeding module 1000 includes a plurality of (in the at least one embodiment, three tiers of) sheet storage portions 1100a to 1100c. The sheet storage portions 1100a to 1100c can each store sheets. The sheet storage portions 1100a to 1100c are configured so that each sheet storage portion can be pulled out to a front side of the apparatus. The sheet storage portions 1100a to 1100c are pulled out to the front side of the apparatus to receive sheets. The sheet feeding module 1000 feeds sheets one by one to the print module 2000. Accordingly, the sheet storage portions 1100a to 1100c are each provided with a separation belt and a conveying roller. The number of the sheet storage portions 1100a to 1100c is an example, and a single tier of sheet storage portion, or two, or four or more, tiers of sheet storage portions may be provided.

The print module 2000 serves as an image forming unit that forms an image on the sheet fed from the sheet feeding module 1000. The print module 2000 includes a first registration unit 2100, a print belt unit 2200, and a recording portion 2300. The first registration unit 2100 corrects a posture, such as a tilt and a position, of the sheet fed from the sheet feeding module 1000, and conveys the corrected sheet to the print belt unit 2200.

The print belt unit 2200 and the recording portion 2300 are arranged so as to face each other across the conveying path of the sheet, on a downstream side of the first registration unit 2100 in a conveyance direction of the sheet. The print belt unit 2200 conveys, by suction, the sheet conveyed from the first registration unit 2100. The recording portion 2300 is a sheet processing portion for forming an image on the sheet conveyed from the print belt unit 2200 by performing, from above the sheet, recording processing (printing) with a recording head. The recording head executes printing by ejecting ink onto the sheet. A clearance between the recording head and the sheet is kept constant through conveyance of the sheet by way of suction by the print belt unit 2200.

A plurality of recording heads are arranged side by side along the conveyance direction of the sheet. The recording heads in the at least one embodiment are five line-type recording heads corresponding to a reaction liquid in addition to four colors of yellow (Y), magenta (M), cyan (C), and black (K). The number of colors and the number of recording heads are not limited to five. Examples of an adoptable inkjet method include a method that uses a heating element, a method that uses a piezo element, a method that uses an electrostatic element, and a method that uses a MEMS element. Ink of each color is supplied to the corresponding recording head via an ink tube from an ink tank (not shown).

The sheet on which printing has been executed by the recording portion 2300 is conveyed by the print belt unit 2200. An in-line scanner (not shown) is placed on a downstream side of the recording portion 2300 in the conveyance direction of the sheet. The in-line scanner is used to correct a printed image by detecting misalignment and color densities of the image formed on the sheet.

The drying module 3000 dries the sheet on which the image has been printed by the print module 2000. The drying module 3000 reduces a liquid constituent contained in the ink by drying the sheet, to thereby improve fixability of the ink to the sheet. The drying module 3000 includes a decoupling portion 3200, a drying belt unit 3300, and a hot air blowing portion 3400.

The sheet on which printing has been executed by the recording portion 2300 of the print module 2000 is conveyed to the decoupling portion 3200 inside the drying module 3000. The decoupling portion 3200 conveys the sheet by lightly holding the sheet with use of a wind pressure from above and friction from a belt. This prevents misalignment of a part of the sheet that remains on the print belt unit 2200 when the sheet lays partially on the decoupling portion 3200 and the rest of the sheet is on the print belt unit 2200.

The sheet conveyed from the decoupling portion 3200 is conveyed by suction by the drying belt unit 3300, and hot air is concurrently blown onto the sheet from the hot air blowing portion 3400 placed above the belt, to thereby dry an ink applied surface (image printed surface). As the drying method, the method of blowing hot air may be combined with a method of irradiating a sheet surface with an electromagnetic wave (an ultraviolet ray, an infrared ray, or the like), or a conductive heat transfer method by contact with a heat generator.

The fixing module 4000 fixes the image to the sheet by heating the sheet that has been dried by the drying module 3000, and thus drying the ink. The fixing module 4000 includes a fixing belt unit 4100 which includes an upper belt unit and a lower belt unit. The fixing module 4000 passes the sheet that has been conveyed from the drying module 3000 between the upper belt unit and the lower belt unit which have each been heated, to thereby allowing the ink solvent to sufficiently permeate (fix to) the sheet.

The cooling module 5000 cools the sheet to which the image has been fixed by the fixing module 4000, to thereby solidify the ink softened from heating, and, at the same time, suppress a temperature change caused in the sheet by a downstream apparatus. The cooling module 5000 includes a plurality of cooling portions 5001. The plurality of cooling portions 5001 cool the high-temperature sheet conveyed from the fixing module 4000. Each of the cooling portions 5001 is configured to cool the sheets by increasing the pressure inside the cooling box by drawing outside air into the cooling box with a fan and applying air blown from a nozzle formed in a conveying guide to the sheet. The plurality of cooling portions 5001 are arranged on both sides of the conveying path so that the sheet can be cooled from both sides.

A conveying path switching portion is provided in the cooling module 5000. The conveying path switching portion switches the conveying path of the sheet between a path on which the sheet is to be conveyed to the reversing module 6000 and a duplex-printing conveying path to be used in duplex printing.

In duplex printing, the sheet is conveyed along the conveying path in a lower part of the cooling module 5000 to be conveyed along each of the duplex-printing conveying paths of the fixing module 4000, the drying module 3000, the print module 2000, and the sheet feeding module 1000. A duplex-printing portion of the fixing module 4000 is provided with a first reversing portion 4200 for reversing a printing surface of the sheet. The sheet on which an image is to be formed on both sides is conveyed to the first reversing portion 4200 once, and then reversed and conveyed to the drying module 3000 side so that the printing surface on which the image is to be printed is reversed from a first surface to a second surface opposite to the first surface. With the sheet passing via the first reversing portion 4200, the front side and the back side of the sheet are reversed, and this enables printing onto the second surface opposite to the first surface of the sheet. After that, the sheet is again conveyed to the first registration unit 2100, the print belt unit 2200, and the recording portion 2300 of the print module 2000 to be printed on. On the duplex-printing conveying path of the drying module 3000 between the first reversing portion 4200 and the first registration unit 2100, a second registration unit 3500 and a color measuring unit 3600 are provided. Details of the second registration unit 3500 and the color measuring unit 3600 are described later.

The reversing module 6000 includes a second reversing portion 6400. The reversing module 6000 can use the second reversing portion 6400 to reverse the front surface and the back surface of the sheet being conveyed. Directions in which the front surface and the back surface of the sheet that is about to be delivered can thus be changed. The delivery stacking module 7000 includes a top tray 7200 and a stacking portion 7500. The delivery stacking module 7000 stacks, in an orderly manner, sheets conveyed from the reversing module 6000 on the top tray 7200 or the stacking portion 7500.

The control device 8000 controls the operation of each module of the inkjet recording apparatus 100. The control device 8000 is an information processing device including a built-in central processing unit (CPU). For example, the control device 8000 controls the operation of the inkjet recording apparatus 100 in accordance with an instruction acquired from an external device connected via a network (not shown) or from a user interface (not shown), to thereby form an image onto a sheet. The control device 8000 may be configured to directly control the operation of each module, or may be configured to transmit an instruction to a controller (not shown) provided in each module to control the operation of each module.

### Duplex-Printing Conveying Path

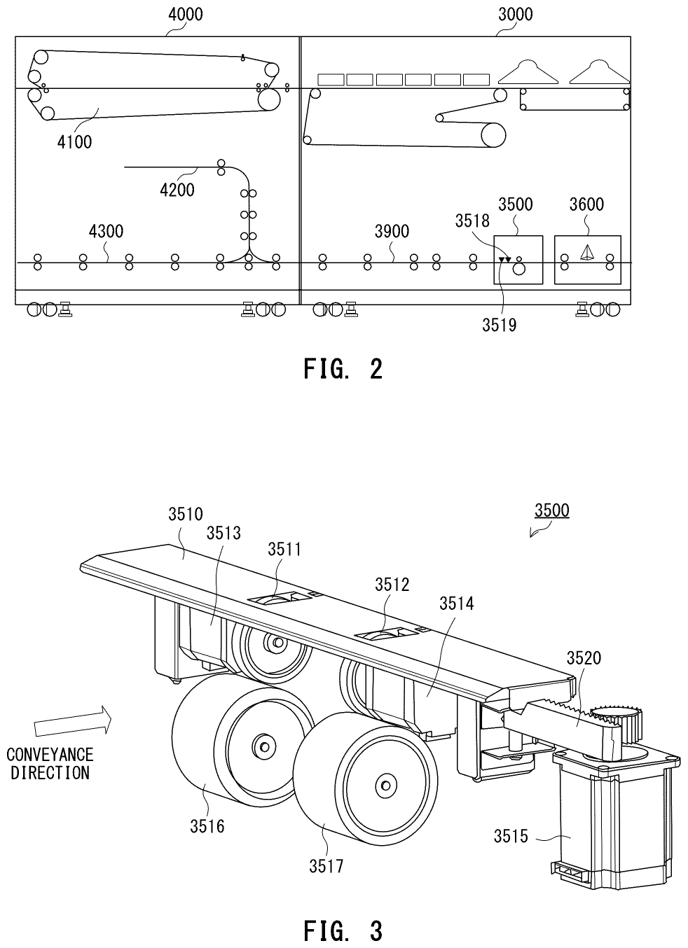

FIG. 2 is a configuration view of the fixing module 4000 and the drying module 3000. As described above, the first reversing portion 4200 is provided on a duplex-printing conveying path 4300 of the fixing module 4000. The second registration unit 3500 and the color measuring unit 3600 which is an example of an image reading sensor are provided on a duplex-printing conveying path 3900 of the drying module 3000. The second registration unit 3500 is provided on the downstream side of the first reversing portion 4200 and on the upstream side of the color measuring unit 3600 in the conveyance direction of the sheet.

The sheet to be conveyed to the second registration unit 3500 is subjected to printing in the print module 2000, and then is conveyed inside of casings of the plurality of modules. Specifically, the sheet is conveyed through the drying module 3000, the fixing module 4000, and the cooling module 5000. In the case of duplex printing, the sheet is further conveyed from a conveying path in a lower part of the cooling module 5000 to the duplex-printing conveying paths 4300 and 3900 of the fixing module 4000 and the drying module 3000. Further, in the fixing module 4000, the printing surface of the sheet is reversed when the sheet passes via the first reversing portion 4200 provided on the duplex-printing conveying path 4300.

The sheet is conveyed by a large number of conveying rollers inside the casings of those plurality of modules. For example, misalignment in an axial direction of rotary shafts of the large number of conveying rollers may cause misalignment in posture of the sheet with respect to the conveyance direction. The misalignment in posture of the sheet includes misalignment (skew feeding) in angle of the sheet with respect to the conveyance direction, and misalignment (lateral registration misalignment) in position of the sheet itself in a direction intersecting with the conveyance direction (hereinafter referred to as “width direction”). The misalignment in posture of the sheet is increased when a path length and the number of conveying rollers required until the sheet is conveyed to the color measuring unit 3600 are increased. Accordingly, before the color measuring unit 3600 reads the sheet, it is required to correct such misalignment in posture with respect to the conveyance direction of the sheet.

The second registration unit 3500 corrects the posture at the time of conveyance such as skew feeding or lateral registration misalignment of the sheet that has been conveyed from the fixing module 4000 to the duplex-printing conveying path 3900. The color measuring unit 3600 is an image reading apparatus for reading an adjusting image formed on the sheet conveyed through the duplex-printing conveying path 3900. The reading result of the adjusting image is used for image adjustment. In this case, the image adjustment is, for example, control for adjusting hue of an image to be formed on the sheet.

The color measuring unit 3600 is provided adjacent to the downstream side of the second registration unit 3500 in the conveyance direction of the sheet. With the color measuring unit 3600 being provided immediately after the second registration unit 3500, the sheet enters the reading position of the color measuring unit 3600 with a certain stable posture after its posture is corrected by the second registration unit 3500.

FIG. 3 is a configuration view of the second registration unit 3500. With reference to FIG. 3, a description is given of an operation of correcting the posture of the sheet performed by the second registration unit 3500.

The second registration unit 3500 includes a skew-feeding corrector 3510. The skew-feeding corrector 3510 includes a registration roller 3511, a registration roller 3512, a registration driving motor 3513, and a registration driving motor 3514. The registration roller 3511 is driven by the registration driving motor 3513. The registration roller 3512 is driven by the registration driving motor 3514. The registration roller 3511 and the registration roller 3512 are independently driven by different driving sources, and hence rotation speeds can be individually changed. With the rotation speeds of the registration roller 3511 and the registration roller 3512 being independently controlled, skew feeding of the sheet can be corrected. The skew-feeding corrector 3510 adjusts the inclination of the sheet with respect to the conveyance direction to an ideal angle. In this case, the ideal angle is an angle in which a leading end of the sheet in the conveyance direction is orthogonal to the conveyance direction of the sheet.

The second registration unit 3500 includes a lateral registration misalignment corrector 3520 and a driving motor 3515 below the skew-feeding corrector 3510. The lateral registration misalignment corrector 3520 can move the entire second registration unit 3500 in the width direction by a driving force supplied from the driving motor 3515. With the entire second registration unit 3500 being moved in the width direction, lateral registration misalignment can be corrected. The lateral registration misalignment corrector 3520 controls the position of the sheet in the width direction to a reference position.

The registration roller 3511 forms a nip portion between the registration roller 3511 and a roller 3516 provided at a position opposed to the registration roller 3511 across the duplex-printing conveying path 3900. The registration roller 3512 forms a nip portion between the registration roller 3512 and a roller 3517 provided at a position opposed to the registration roller 3512 across the duplex-printing conveying path 3900. In the vicinity of the upstream side of those nip portions in the conveyance direction of the sheet, a plurality of registration sensors 3518 illustrated in FIG. 2 are provided at the same position in the conveyance direction and at different positions in the width direction. The registration sensor 3518 is a sheet detecting sensor for detecting the conveyed sheet. The control device 8000 calculates a current skew feeding amount of the sheet (inclination of the leading end of the sheet with respect to the width direction) based on the timing at which each of the plurality of registration sensors 3518 detects the sheet, and the conveying speed of the sheet. A sensor to be used to detect the skew feeding amount of the sheet is not limited to the plurality of registration sensors 3518, and may be, for example, a line sensor for reading the leading end of the sheet.

In the vicinity of the registration roller 3511 and the registration roller 3512, an image sensor 3519 illustrated in FIG. 2 is provided. The image sensor 3519 is a sheet reading sensor for reading a sheet conveyed to the nip portion. The control device 8000 detects an edge position of an end portion of the sheet in the width direction, based on a reading result of the sheet obtained by the image sensor 3519. The control device 8000 calculates a lateral registration misalignment amount of the sheet based on the detected edge position. The lateral registration misalignment amount is a misalignment amount of the sheet from the reference position in a direction intersecting with the conveyance direction of the sheet.

The control device 8000 controls the drive of the registration driving motors 3513 and 3514 and the driving motor 3515 based on the skew feeding amount and the lateral registration misalignment amount of the sheet detected through use of the registration sensors 3518 and the image sensor 3519. In this manner, skew feeding correction and lateral registration misalignment correction of the sheet are performed. When the inclination of the leading end of the sheet is controlled to an ideal angle and the position of the sheet in the width direction is controlled to the reference position, the adjusting image formed on the sheet that has passed through the second registration unit 3500 can pass through a reading position of a color sensor 61.

In FIG. 2, the image sensor 3519 is provided on the upstream of the registration sensors 3518 in the conveyance direction of the sheet, but the image sensor 3519 may be configured to be provided on the downstream of the registration sensors 3518 in the conveyance direction of the sheet. Further, the skew feeding amount of the sheet can be detected by detecting an edge position of a leading end part in the conveyance direction of the sheet based on a reading result of the sheet obtained by the image sensor 3519. Accordingly, without using the registration sensors 3518, the skew feeding amount and the lateral registration misalignment amount of the sheet may be detected only by the image sensor 3519.

### Color Measuring Unit

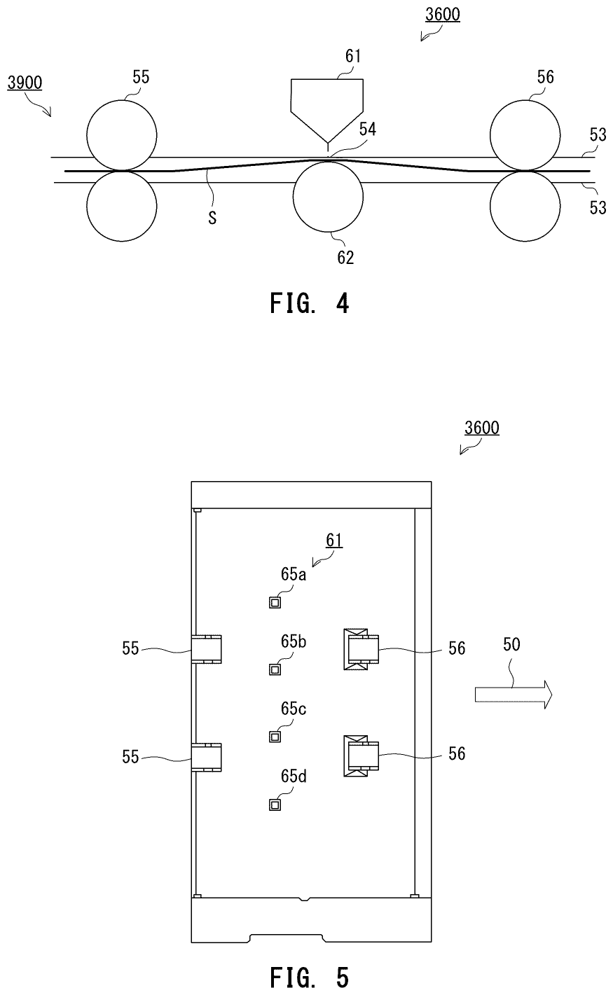

A description is given of image adjustment (color adjustment) performed through use of the color measuring unit 3600. FIG. 4 is a cross-sectional view of the color measuring unit 3600. The duplex-printing conveying path 3900 includes two conveying guides 53, and conveys a sheet S between the two conveying guides 53. The color measuring unit 3600 includes, along the conveying guides 53, a first conveying roller pair 55, the color sensor 61, a sponge roller 62, and a second conveying roller pair 56. The first conveying roller pair 55 is provided on the upstream side of the second conveying roller pair 56 in the conveyance direction of the sheet S. The color sensor 61 and the sponge roller 62 are arranged at positions opposed to each other across the conveying guide 53. The color sensor 61 and the sponge roller 62 are provided between the first conveying roller pair 55 and the second conveying roller pair 56.

The conveying guide 53 has a hole 54 provided as a detection window at the reading position of the color sensor 61. At the time of reading the sheet S by the color sensor 61, the sheet S is nipped by both of the first conveying roller pair 55 and the second conveying roller pair 56. With the sheet S being nipped by the first conveying roller pair 55 and the second conveying roller pair 56, the sheet S is brought into a state of being stretched at a predetermined tension, and hence its posture is stabilized. The sponge roller 62 pushes the sheet S toward the hole 54. With the sponge roller 62 pushing the sheet S toward the hole 54, a distance between the color sensor 61 and the sheet S is kept constant. Accordingly, the color sensor 61 can read the image formed on the sheet S with high accuracy.

FIG. 5 is a view of the color measuring unit 3600 as viewed from the sponge roller 62 side. The color sensor 61 includes a plurality of detectors 65a, 65b, 65c, and 65d formed on a straight line in the width direction intersecting with a conveyance direction 50 of the sheet S. In the at least one embodiment, the number of detectors is four.

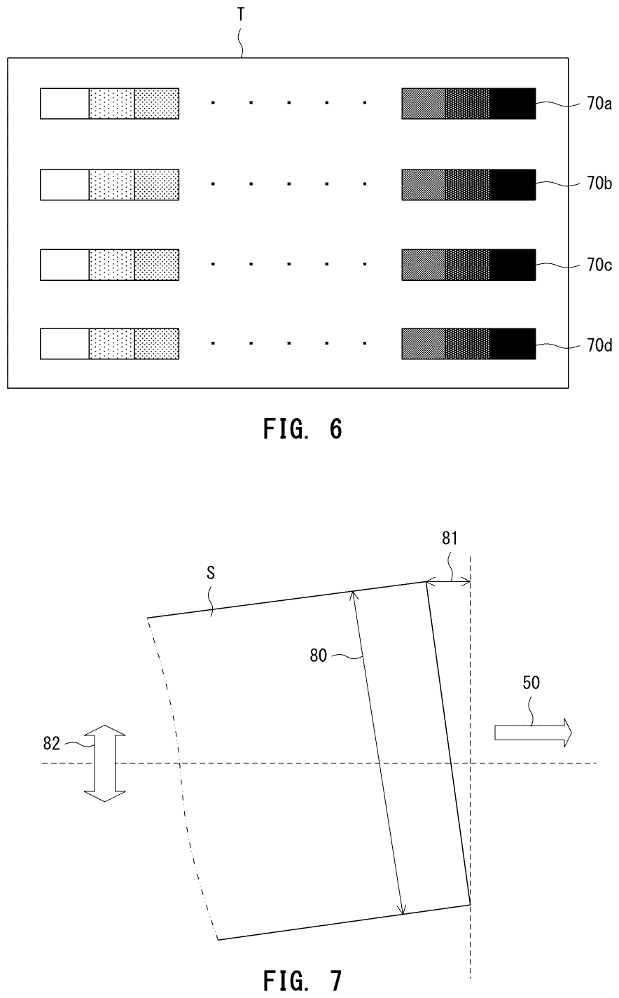

FIG. 6 is an exemplary view of a test chart obtained by printing the adjusting image on the sheet S. A test chart T includes four patch image rows 70a, 70b, 70c, and 70d as the adjusting image. In each of the patch image rows 70a, 70b, 70c, and 70d, a plurality of (in the at least one embodiment, nineteen colors of) patch images having different colors are formed adjacent to each other.

Each of the patch image rows 70a, 70b, 70c, and 70d corresponds to one detector. In the example of FIG. 6, the patch image row 70a corresponds to the detector 65a. The patch image row 70b corresponds to the detector 65b. The patch image row 70c corresponds to the detector 65c. The patch image row 70d corresponds to the detector 65d. The patch image rows 70a, 70b, 70c, and 70d are read by the corresponding detectors 65a, 65b, 65c, and 65d. Accordingly, the patch image rows 70a, 70b, 70c, and 70d are printed on the test chart T so as to pass through the reading positions of the corresponding detectors 65a, 65b, 65c, and 65d.

In the at least one embodiment, four patch image rows 70a, 70b, 70c, and 70d are printed for four detectors 65a, 65b, 65c, and 65d, but the number of patch image rows is determined in accordance with the number of detectors. That is, as long as the number of detectors and the number of patch image rows are the same, the number of detectors and the number of patch image rows are each not limited to four.

The control device 8000 stores in advance values each indicating the original hue of each of the patch images of the patch image rows 70a, 70b, 70c, and 70d printed on the test chart T. The control device 8000 compares those values stored in advance with reading results of the respective patch image rows 70a, 70b, 70c, and 70d obtained by the respective detectors 65a, 65b, 65c, and 65d, and acquires a correction value of the hue based on results of the comparison. The control device 8000 generates an image forming condition through use of the above-mentioned correction value. The control device 8000 controls the print module 2000 based on the above-mentioned image forming condition to thereby control the color tone of the image that should be formed after image adjustment to the ideal color tone. The image adjustment is not limited to the adjustment of the hue, and may be control of generating the image forming condition for adjusting the density of the image to be formed.

In a case where the adjusting image is read by the color sensor 61, it is distinguished from a case in which a normal operation corresponding to a printing job is performed, and, for example, patch images are printed on the sheet S having a predetermined size such as A3. The number of required patch images corresponds to 1,617 colors to comply with the standard of Japan Color (“International Standard for Digital Proof: ISO 12647-7” and “ISO 12642-2 (1,617-color chart)”). In the at least one embodiment, patch images of “four rows×nineteen colors” are printed on one test chart T, and hence twenty-two test charts T are required for color measurement.

It is preferred that the size of the sheet S to be used for the test chart T be as large as possible. This is because, as the size is decreased, the number of required test charts T is increased, and hence the productivity is reduced. Further, it is preferred that the patch image row include as many patch images as possible. The number of patch images included in the patch image row is determined based on the reading speed of the color sensor 61 and the conveying speed of the test chart T. In the at least one embodiment, one row of patch images includes nineteen colors of patch images, however, for example, when the conveying speed is changed, the number of patch images per row of patch images can be changed.

### Reading Accuracy

A description is given of an influence of the skew feeding correction and the lateral registration misalignment correction performed by the second registration unit 3500, on the reading accuracy to be achieved by the color measuring unit 3600. FIG. 7 is an explanatory view of the posture of the sheet S conveyed through the duplex-printing conveying path 3900 to the second registration unit 3500.

In FIG. 7, the sheet S has an A3 size used for the test chart T, and is conveyed with its longitudinal direction serving as the conveyance direction 50. A sheet width 80 is 297 mm. In this case, a skew feeding amount 81 of the sheet S is, for example, about 21 mm at maximum with respect to the direction of the width direction intersecting with the conveyance direction 50. Further, a lateral registration misalignment amount 82 is, for example, ±17 mm at maximum. The skew feeding and the lateral registration misalignment of the sheet S are caused when the sheet S receives an influence during conveyance such as delivery between modules.

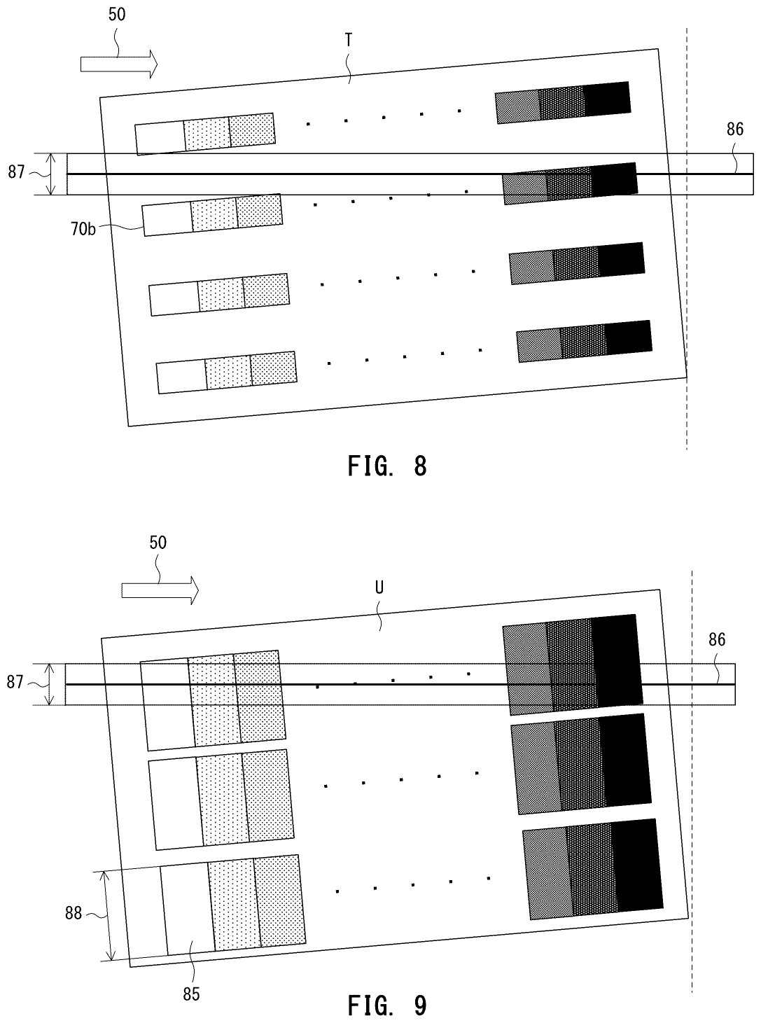

FIG. 8 is an explanatory view of a reading position at the time of reading the test chart T by the color measuring unit 3600 in a case where no correction is performed by the second registration unit 3500. FIG. 8 exemplifies a case in which the detector 65b of the color sensor 61 reads the patch image row 70b. The detector 65b reads the conveyed test chart T at a reading position 86. The test chart T has lateral registration misalignment 87.

In this case, the test chart T conveyed in the conveyance direction 50 has, in the patch image row 70b, a patch image to which reading is performed by the detector 65b and a patch image to which reading is not performed by the detector 65b. Similarly, for the other patch image rows 70a, 70c, and 70d, there are patch images to which reading is performed and patch images to which reading is not performed. The lateral registration misalignment amount 87 is wider than the width of the patch image row 70b, and hence occurrence of the lateral registration misalignment causes a reading failure to occur in a wider range.

In order to read all patch images from the test chart T conveyed while having the skew feeding and the lateral registration misalignment, it is required to increase the width of each patch image. FIG. 9 is an explanatory view of the reading position at the time of reading the test chart T having formed thereon patch images with a larger width. The size of the test chart T and the lateral registration misalignment amount 87 are the same as those of FIG. 8.

A width 88 of the patch image 85 is determined based on the skew feeding amount and the lateral registration misalignment amount 87, and on a reading range read by the detector. For example, the width 88 of the patch image 85 is required to be about 80 mm or more. Further, in a case where the patch image row is formed in consideration of the formation position misalignment of the patch image and the installing position tolerance of the color measuring unit 3600, only three patch image rows can be formed at maximum on an A3-sized test chart U.

As described above, in a case where the test chart U is conveyed in a state in which the skew feeding and the lateral registration misalignment are not corrected, the number of patch images read by the color measuring unit 3600 from one test chart U is reduced as compared to the case of the test chart T. As described above, in a case where 1,617 colors of patch images are to be read, about twenty nine test charts U are required, and hence the productivity is reduced.

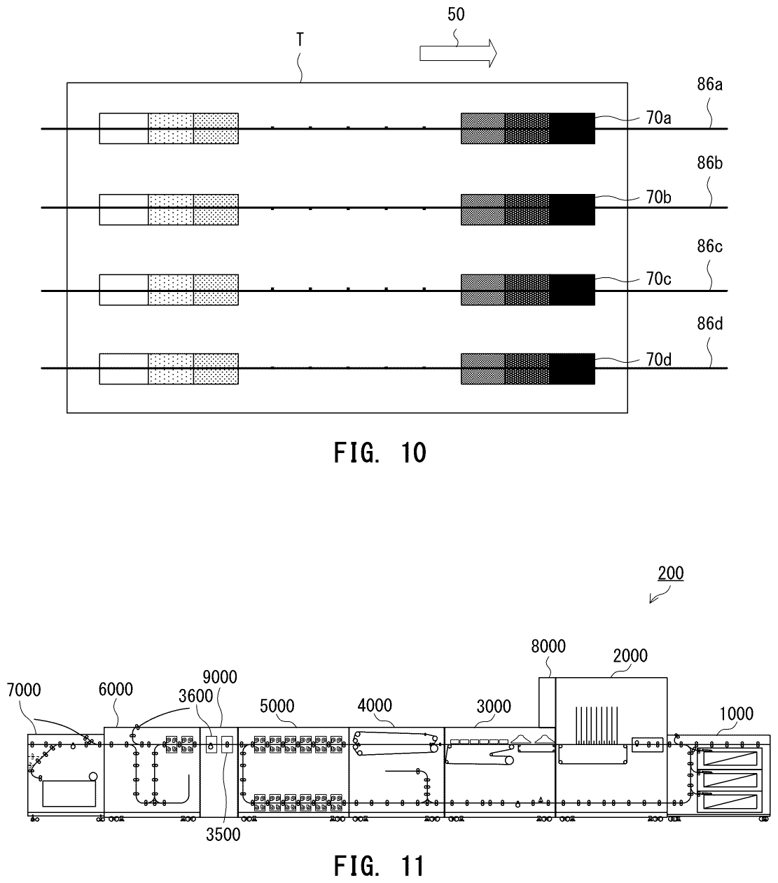

In view of the above, in the at least one embodiment, the second registration unit 3500 is arranged on the upstream side of the color measuring unit 3600 in the conveyance direction of the sheet so that the skew feeding and the lateral registration misalignment of the test chart conveyed to the color measuring unit 3600 are corrected. Through correction of the skew feeding and the lateral registration misalignment, the test chart is conveyed to the reading position of the color measuring unit 3600 with a stable posture. FIG. 10 is an explanatory view of the reading position in a case in which the test chart T is read with the skew feeding and the lateral registration misalignment being corrected.

The detectors 65a, 65b, 65c, and 65d of the color measuring unit 3600 (color sensor 61) read the patch image rows 70a, 70b, 70c, and 70d at reading positions 86a, 86b, 86c, and 86d, respectively. The skew feeding and the lateral registration misalignment of the test chart T are corrected, and hence the patch images included in each of the patch image rows 70a, 70b, 70c, and 70d are aligned on a straight line in the conveyance direction 50 of the sheet. Accordingly, the patch images included in the patch image rows 70a, 70b, 70c, and 70d pass through the reading positions 86a, 86b, 86c, and 86d of the detectors 65a, 65b, 65c, and 65d, respectively. In this manner, all of the patch images (adjusting image) formed on the test chart T can pass through the corresponding reading positions, and hence the color measuring unit 3600 can accurately read all of the patch images (adjusting image) formed on the test chart T.

The control device 8000 acquires a reading result of the adjusting image formed on the test chart T from the color measuring unit 3600. The control device 8000 performs image adjustment based on the acquired reading result of the adjusting image, and generates the image forming condition to be used at the time of next image formation. The control device 8000 can acquire an accurate reading result of the adjusting image from the color measuring unit 3600, and hence the image quality of the image to be formed by the image forming system can be adjusted with high accuracy.

A description has been given above of an example of an adjusting image for correcting the hue, but the adjusting image is only required to be an image for performing image adjustment. For example, the adjusting image may be an image for correcting a tone or an image density. Further, the at least one embodiment is effective even in a case of an adjusting image for correcting a geometric characteristic of an image such as a position or an inclination of the image.

A description has been given above of a configuration in which the second registration unit 3500 and the color measuring unit 3600 are provided on the duplex-printing conveying path 3900, but the arrangement of the second registration unit 3500 and the color measuring unit 3600 is not limited thereto. The second registration unit 3500 and the color measuring unit 3600 are only required to be provided at positions after the image is fixed to the sheet and before the sheet is delivered or stacked from the delivery stacking module 7000.

For example, the image reading apparatus including the second registration unit 3500 and the color measuring unit 3600 may be configured to be provided between the cooling module 5000 and the reversing module 6000. FIG. 11 is a configuration view of an inkjet recording apparatus 200 in this case. In this case, the test chart T is conveyed from the cooling module 5000 to an image reading apparatus 9000. The image reading apparatus 9000 stabilizes the posture of the test chart T by the second registration unit 3500, and reads the adjusting image by the color measuring unit 3600.

In the at least one embodiment, a description has been given of the inkjet recording apparatus 100 as the image forming system, but the image forming system may be configured to form an image by systems other than the inkjet system, such as an electrophotographic system. In any case, it is only required to provide the registration unit for correcting the posture at the time of conveyance of the sheet such as skew feeding or lateral registration misalignment of the sheet, on the upstream side, in the conveyance direction of the sheet, of the image reading sensor for reading the adjusting image from the sheet having the adjusting image formed thereon.

According to the present disclosure as described above, the posture of the sheet is corrected on the upstream side of the color measuring unit 3600, and thus the adjusting image can be accurately read.

While the present disclosure has been described with reference to exemplary embodiments, it is to be understood that the present disclosure is not limited to the disclosed exemplary embodiments. The scope of the following claims is to be accorded the broadest interpretation so as to encompass all such modifications and equivalent structures and functions.

This application claims the benefit of Japanese Patent Application No. 2024-170713, filed Sep. 30, 2024, which is hereby incorporated by reference herein in its entirety.

What is claimed is:

1. An image forming system comprising:
an image forming unit configured to form an image on a sheet;
a reversing portion in which a front side and a back side of the sheet are to be reversed in order to form an image on a surface opposite to a surface of the sheet on which the image has been formed by the image forming unit;
a duplex-printing conveying path for use in conveying the sheet having the front side and the back side reversed by the reversing portion to the image forming unit;
a registration unit configured to correct a skew of the sheet conveyed to the duplex-printing conveying path; and
an image reading sensor configured to read the image formed on the sheet having the skew corrected by the registration unit in the duplex-printing conveying path.

2. The image forming system according to claim 1, further comprising:
a drying module configured to dry the sheet having the image formed thereon by the image forming unit;
a fixing module configured to fix the image to the sheet dried by the drying module; and
a cooling module configured to cool the sheet having the image fixed thereto by the fixing module,
wherein the cooling module is configured to convey the sheet cooled during duplex printing to the reversing portion,
wherein the fixing module includes the reversing portion, and
wherein the drying module includes the registration unit and the image reading sensor.

3. The image forming system according to claim 2,
wherein the image reading sensor is provided adjacent to a downstream side of the registration unit in a conveyance direction of the sheet.

4. The image forming system according to claim 3,
wherein the registration unit is provided on a downstream side of the reversing portion in the conveyance direction.

5. The image forming system according to claim 1,
wherein the image forming unit is configured to form an adjusting image on the sheet, and
wherein the image reading sensor is configured to read the adjusting image.

6. The image forming system according to claim 5,
wherein the image reading sensor includes a plurality of detectors arranged on a straight line in a direction intersecting with a conveyance direction of the sheet, and
wherein the image forming unit is configured to form the adjusting image at a position corresponding to a reading position of each of the plurality of detectors.

7. The image forming system according to claim 5, further comprising
a generator configured to generate an image forming condition based on a reading result of the adjusting image obtained by the image reading sensor.

8. The image forming system according to claim 1,
wherein the registration unit includes a corrector configured to correct misalignment of a position of the sheet in a direction intersecting with a conveyance direction of the sheet.

9. The image forming system according to claim 8,
wherein the registration unit includes a plurality of sheet detectors arranged at different positions in the direction intersecting with the conveyance direction of the sheet, and
wherein the registration unit is configured to correct the skew feeding of the sheet based on a skew feeding amount of the sheet calculated based on a timing at which each of the plurality of sheet detectors detects the sheet and on a conveying speed of the sheet.

10. The image forming system according to claim 8,
wherein the registration unit includes a sheet reading sensor configured to read the sheet, and
wherein the corrector is configured to correct the misalignment of the sheet based on a misalignment amount from a reference position of an edge position of an end portion in the direction intersecting with the conveyance direction of the sheet, the edge position being detected from a reading result of the sheet obtained by the sheet reading sensor.

11. The image forming system according to claim 9,
wherein the registration unit includes a sheet reading sensor configured to read the sheet, and
wherein the corrector is configured to correct the misalignment of the sheet based on a misalignment amount from a reference position of an edge position of an end portion in the direction intersecting with the conveyance direction of the sheet, the edge position being detected from a reading result of the sheet obtained by the sheet reading sensor.

12. The image forming system according to claim 8,
wherein the registration unit includes a sheet reading sensor configured to read the sheet,
wherein the registration unit is configured to correct the skew feeding of the sheet based on a skew feeding amount of the sheet obtained from an edge position of a leading end part in the conveyance direction of the sheet, the edge position being detected from a reading result of the sheet obtained by the sheet reading sensor.

13. An image reading apparatus to be provided in an image forming system that is capable of forming images on both sides of a sheet, the image forming system comprising:
an image forming unit configured to form an image on a sheet;
a reversing portion in which a front side and a back side of the sheet are to be reversed in order to form an image on a surface opposite to a surface of the sheet on which the image has been formed by the image forming unit;
a duplex-printing conveying path for use in conveying the sheet having the front side and the back side reversed by the reversing portion to the image forming unit,
wherein the image reading apparatus comprising:
a registration unit configured to correct a skew of the sheet conveyed to the duplex-printing conveying path; and
an image reading sensor configured to read the image formed on the sheet having the skew corrected by the registration unit in the duplex-printing conveying path.
